(19) United States
(12) Patent Application Publication
(10) Pub. No.: US 2025/0368079 A1
(43) Pub. Date: Dec. 4, 2025

(54) CONTROL DEVICE AND CONTROL METHOD

(71) Applicant: HONDA MOTOR CO., LTD., Tokyo (JP)

(72) Inventors: Takahiro YASUE, Saitama (JP); Yasuo Yamada, Saitama (JP); Yasushi Ogihara, Saitama (JP)

(73) Assignee: HONDA MOTOR CO., LTD., Tokyo (JP)

(21) Appl. No.: 19/224,890

(22) Filed: Jun. 2, 2025

(30) Foreign Application Priority Data
Jun. 3, 2024 (JP) 2024-089768

(51) Int. Cl. B60L 53/62; B60L 58/24

(52) U.S. Cl. CPC B60L 53/62; B60L 58/24; B60L 2240/545

(57) ABSTRACT

A control device which controls a vehicle including a battery implemented by an all-solid-state battery includes: an acquisition circuit configured to acquire a battery temperature that is a temperature of the battery; and a charging control circuit configured to, when the battery temperature acquired by the acquisition circuit reaches a predetermined upper limit temperature during charging of the battery, stop the charging of the battery or decrease a charging current as compared with before the battery temperature reaches the predetermined upper limit temperature. The charging control circuit sets the upper limit temperature to a first upper limit temperature when a charging time for charging the battery is longer than a predetermined time, and sets the upper limit temperature to a second upper limit temperature higher than the first upper limit temperature when the charging time is equal to or shorter than the predetermined time.

### CROSS-REFERENCE TO RELATED APPLICATIONS

This application is based on and claims priority under 35 USC 119 from Japanese Patent Application No. 2024-089768 filed on Jun. 3, 2024, the contents of which are incorporated herein by reference.

### TECHNICAL FIELD

The present disclosure relates to a control device and a control method.

### BACKGROUND

In recent years, efforts to realize a low-carbon society or a decarbonized society become active, and research and development about an electrification technique are conducted to reduce CO₂ emission and improve energy efficiency in vehicles.

For example, Japanese Patent Publication No. 4049959 discloses a battery charging method in which a battery is charged with a constant current within an upper limit range of a temperature increase of the battery.

However, in the related art, there is a room for improvement in terms of realizing more efficient charging while preventing deterioration of a battery.

The present disclosure relates to provide a control device and a control method capable of realizing more efficient charging while preventing deterioration of a battery.

### SUMMARY

A first aspect of the present disclosure relates to a control device which controls a vehicle including a battery implemented by an all-solid-state battery, the control device including:
an acquisition circuit configured to acquire a battery temperature that is a temperature of the battery; and
a charging control circuit configured to, when the battery temperature acquired by the acquisition circuit reaches a predetermined upper limit temperature during charging of the battery, stop the charging of the battery or decrease a charging current as compared with before the battery temperature reaches the predetermined upper limit temperature, in which
the charging control circuit
   sets the upper limit temperature to a first upper limit temperature when a charging time for charging the battery is longer than a predetermined time, and
   sets the upper limit temperature to a second upper limit temperature higher than the first upper limit temperature when the charging time is equal to or shorter than the predetermined time.

A second aspect of the present disclosure relates to a control method performed by a computer which controls a vehicle including a battery implemented by an all-solid-state battery, the control method including:
acquiring a battery temperature that is a temperature of the battery;
when the acquired battery temperature reaches a predetermined upper limit temperature during charging of the battery, stopping the charging of the battery or decreasing a charging current as compared with before the battery temperature reaches the upper limit temperature;
setting the upper limit temperature to a first upper limit temperature when a charging time for charging the battery is longer than a predetermined time; and
setting the upper limit temperature to a second upper limit temperature higher than the first upper limit temperature when the charging time is equal to or shorter than the predetermined time.

### BRIEF DESCRIPTION OF DRAWINGS

Exemplary embodiments of the present disclosure will be described in detail based on the following figures, wherein:

FIG. 1 is a diagram showing an example of a battery charging system 1 according to the present embodiment;

FIG. 2 is a block diagram showing a configuration of a vehicle 10 equipped with a control device 50;

FIG. 3 is a time chart showing an example of changes in a charging current, a battery temperature, and an SOC; and

FIG. 4 is a time chart showing an example of the changes in the charging current, the battery temperature, and the SOC in another embodiment.

### DESCRIPTION OF EMBODIMENTS

Hereinafter, an embodiment will be described with reference to the accompanying drawings.

The following embodiment does not limit the present disclosure, and not all of elements described in the following embodiment are necessary to the present disclosure.

Two or more elements described in the following embodiment may be freely combined without departing from the gist of the present disclosure. Hereinafter, the same or similar elements are denoted by the same or similar reference signs, and a description thereof may be omitted or simplified.

A control device 50 in the present embodiment is mounted on a vehicle 10, and the control device 50 performs charging control of a battery 20 mounted on the vehicle 10.

### Charging System

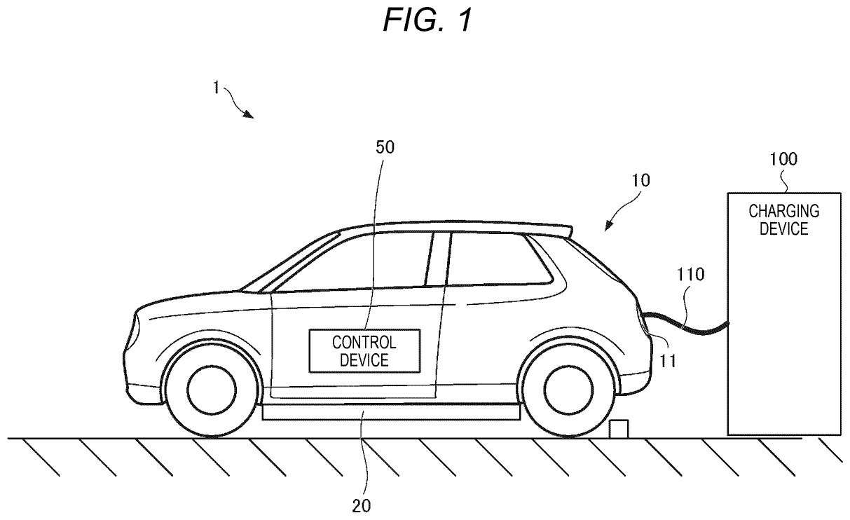

FIG. 1 is a diagram schematically showing a configuration of a charging system 1 according to the present embodiment. The charging system 1 includes the vehicle 10 and a charging device 100. The vehicle 10 is a vehicle that includes the battery 20 and can charge (that is, externally charge) the battery 20 with electric power supplied from the charging device 100. As the vehicle 10, for example, an electric automobile or a plug-in hybrid vehicle that travels by driving a drive source such as a motor with electric power of the battery 20 is assumed.

The charging device 100 is provided at a charging stand (also referred to as a charging station) in, for example, a parking area of an expressway, a shopping mall, or the like, and can perform normal charging and quick charging in which a larger current than in the normal charging flows to perform the charging. In the present embodiment, it is particularly assumed that the battery 20 is charged by quick charging. Therefore, in the following description, charging means “quick charging” unless otherwise specified. Electric power is supplied to the charging device 100 from a power grid (power system) (not shown), and the charging device 100 operates with the supplied electric power.

The charging device 100 includes a connection portion 110 including a cable and a connector. The connection portion 110 exchanges electric power between the charging device 100 and the vehicle 10 in a state of being connected to a charging inlet 11 of the vehicle 10.

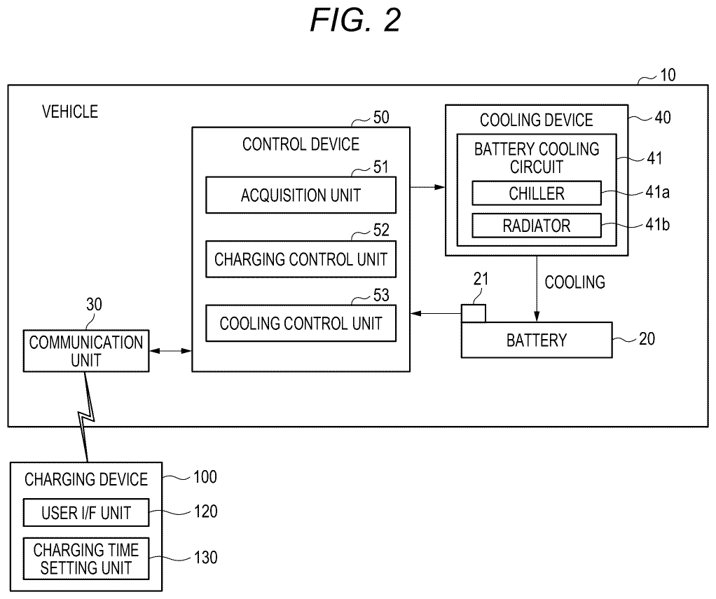

As shown in FIG. 2, the charging device 100 includes a user I/F unit 120 and a charging time setting unit 130. The user I/F unit 120 is an interface unit for receiving an instruction from a user (for example, an occupant such as a driver) and providing various types of information to the user, and includes a display unit including a touch panel (not shown), an input unit, and an output unit such as a speaker. The charging time setting unit 130 sets a time for supplying electric power from the charging device 100 to the battery 20 based on a charging time input by the user via the user I/F unit 120. The charging time setting unit 130 transmits, to the vehicle 10, information indicating that the charging time is set. The transmitted information on the charging time is a part of parameters executed by the control device 50. When the user does not set the charging time, the charging time setting unit 130 may set the charging time to a predetermined charging time.

### Vehicle

Next, a configuration of the vehicle 10 will be described. As shown in FIG. 2, the vehicle 10 includes the battery 20, a communication unit 30, a cooling device 40, and the control device 50.

The battery 20 is a chargeable and dischargeable power storage device, and is implemented by, for example, an all-solid-state battery. The all-solid-state battery is a battery using a nonflammable solid electrolyte as an electrolyte, and is excellent in durability and heat resistance, for example, as compared with a liquid battery including a liquid electrolyte containing a flammable organic solvent. The battery 20 is implemented by, for example, a battery pack in which a plurality of battery modules are connected in series or in series-parallel, and is disposed under a floor of the vehicle 10. Each of the battery modules is configured by connecting a plurality of all-solid-state battery cells in series or in series-parallel.

The battery 20 is electrically connected to the motor (not shown) that is the drive source of the vehicle 10, and drives the vehicle 10 by supplying stored electric power to the motor. The battery 20 can store the electric power supplied from the charging device 100 and electric power regenerated by the motor.

A battery sensor 21 is attached to the battery 20, and the battery sensor 21 includes, for example, a voltage sensor, a current sensor, and a temperature sensor. The voltage sensor, the current sensor, and the temperature sensor detect a current value, a voltage value, and a temperature of the battery 20, respectively. The battery sensor 21 outputs the detected current value, voltage value, and temperature to the control device 50.

The communication unit 30 is a communication interface that communicates with an external device such as the charging device 100 according to a control instruction from the control device 50. That is, the control device 50 may communicate with the external device such as the charging device 100 via the communication unit 30. Examples of the external device can include a terminal device (for example, a smartphone) of the driver and a server device managed by a manufacturer of the vehicle 10, in addition to the charging device 100. For example, WI-FI (registered trademark), or Bluetooth (registered trademark) can be adopted for communication between the vehicle 10 and the external device.

The cooling device 40 includes a battery cooling circuit 41 that cools the battery 20. The battery cooling circuit 41 includes, for example, a chiller 41a and a radiator 41b, and cools the battery 20 by, for example, driving an electric pump (not shown) to circulate a refrigerant and exchanging heat accumulated in the refrigerant. The cooling device 40 is controlled by the control device 50 to be described later. The cooling device 40 only needs to be able to cool at least the battery 20, and thus may be partially shared with a cooling system for air conditioning, a system for cooling a power conversion device (not shown) such as the motor serving as the drive source or an inverter, and the like.

The battery 20 is cooled by traveling wind (that is, outside air) generated when the vehicle 10 travels, in addition to being cooled by the cooling device 40.

The control device 50 is a computer that includes, for example, a processor for performing various calculations, a storage unit having a non-transitory storage medium for storing various kinds of information, and an input and output unit that controls input and output of data between an inside and outside of the control device 50 (none of which are shown), and executes overall control of the vehicle 10. For example, the control device 50 is implemented by one electronic control unit (ECU) or by a plurality of ECUs working in cooperation with each other.

The control device 50 executes, for example, various programs stored in the storage unit. Regarding charging control known in the related art, the charging control is generally performed on a liquid battery mounted on a vehicle. For example, an upper limit temperature is set considering durability of the battery, and when the battery is charged, the charging is performed within a range not exceeding the upper limit temperature. On the other hand, when quick charging is performed under such a condition, a larger current flows through the battery than in normal charging, so that a temperature of the battery reaches the upper limit temperature early, and a charging time may be prolonged. That is, there is a possibility that the upper limit temperature of the liquid battery is a restriction and a demand for quick charging cannot be met. Therefore, the present embodiment is configured such that charging control of the battery 20 is performed using an all-solid-state battery having a higher upper limit temperature considering durability than a liquid battery as the battery 20.

Specifically, the control device 50 executes, as an example of the program recorded in the storage unit, a charging control process program for stopping charging of the battery 20 or controlling a charging current of the battery 20 according to the charging time of the battery 20 or the temperature of the battery 20. The control device 50 includes an acquisition unit 51, a charging control unit 52, and a cooling control unit 53 as functional units implemented by executing the program. In the following, processing described as being performed by the acquisition unit 51, the charging control unit 52, and the cooling control unit 53 is processing implemented by the control device 50.

The acquisition unit 51 acquires a battery temperature that is the temperature of the battery 20 (hereinafter, also referred to as the “battery temperature”). Specifically, the acquisition unit 51 acquires the battery temperature based on a detection value of the battery sensor 21. As described above, since the battery 20 includes a plurality of battery modules, for example, the battery temperature may be acquired for each of the battery modules, or a highest temperature among the plurality of battery modules may be acquired as the battery temperature.

When the battery temperature reaches a predetermined upper limit temperature during the charging of the battery 20, the charging control unit 52 stops the charging of the battery 20 or decreases the charging current as compared with before the battery temperature reaches the upper limit temperature. Specifically, when the battery temperature acquired by a function of the acquisition unit 51 reaches the predetermined upper limit temperature, the charging control unit 52 stops the charging of the battery 20 or decreases the charging current as compared with before the battery temperature reaches the upper limit temperature. The upper limit temperature indicates a temperature higher than at least an upper limit temperature that can be set for the liquid battery, and in the present embodiment, since an all-solid-state battery is used as the battery 20, the upper limit temperature is set to a temperature T1 considering durability of the all-solid-state battery. The temperature T1 considering the durability of the all-solid-state battery is a “first upper limit temperature” of the present embodiment.

Meanwhile, there is also a possibility that charging at a second upper limit temperature higher than the first upper limit temperature is temporarily permitted while considering the durability of the battery 20 (in other words, while considering deterioration of the battery 20). In recent years, there has been an increasing demand for quick charging, and therefore it is desired to efficiently charge the battery 20. Therefore, in the present embodiment, when the charging time is equal to or shorter than a predetermined time, the charging control unit 52 sets the upper limit temperature to a second upper limit temperature higher than the first upper limit temperature and performs the charging control.

Specifically, the charging control unit 52 acquires the charging time designated by the user, and sets the second upper limit temperature of the battery 20 corresponding to the charging time. Here, the second upper limit temperature is, for example, a temperature allowing charging at a temperature temporarily exceeding the first upper limit temperature that is a temperature considering the durability of the all-solid-state battery, and the second upper limit temperature is set according to the charging time. For example, the charging control unit 52 sets the upper limit temperature of the battery 20 to the second upper limit temperature when the charging time is equal to or shorter than a predetermined time. In other words, when the charging time is longer than the predetermined time, the upper limit temperature is set to the first upper limit temperature. The “predetermined time” is a time allowing charging at a temperature temporarily exceeding the first upper limit temperature described above, and is set considering the durability of the all-solid-state battery, similarly to the upper limit temperature of the battery 20.

More specifically, the charge control unit 52 sets the second upper limit temperature to be higher as the charging time becomes shorter. For example, the charging control unit 52 sets the second upper limit temperature to T2 when the charging time is γ, sets the second upper limit temperature to T3 when the charging time is β, and sets the second upper limit temperature to T4 when the charging time is α. In this way, the second upper limit temperature is set to a predetermined temperature range higher than the first upper limit temperature, and the charging control unit 52 sets the second upper limit temperature to be relatively higher within the predetermined temperature range as the charging time becomes shorter.

When the battery temperature reaches the second upper limit temperature, the charging control unit 52 decreases the charging current to a predetermined charging current. That is, when the battery temperature reaches the second upper limit temperature, the charging control unit 52 performs power saving by limiting the charging current of the battery 20 such that the temperature of the battery 20 does not increase to the second upper limit temperature or higher. For example, the charging control unit 52 performs control to set a maximum current allowed in the battery 20 (hereinafter, also referred to as the “maximum current”) as the charging current before the battery temperature reaches the second upper limit temperature, and decreases the charging current to a predetermined charging current lower than the maximum current when the battery temperature reaches the second upper limit temperature. The predetermined charging current is, for example, a charging current with which the charging can be performed at the second upper limit temperature before the set charging time elapses, and thus a charging amount of the battery 20 can be increased as much as possible in the set charging time. That is, when the battery temperature reaches the second upper limit temperature, the charging control unit 52 controls the charging current in the charging device 100 such that the battery temperature is maintained at the second upper limit temperature.

As described above, when the charging time is longer than the predetermined time, the charging control unit 52 may set the upper limit temperature of the battery 20 to the first upper limit temperature. At this time, the charging control unit 52 sets the maximum current as the charging current of the battery 20 before the battery temperature reaches the first upper limit temperature, and decreases the charging current from the maximum current to a predetermined charging current with which the first upper limit temperature is maintained when the battery temperature reaches the first upper limit temperature. The predetermined time in the charging time, the first upper limit temperature, and the second upper limit temperature may be determined in advance by, for example, an experiment or the like by a manufacturer or the like of the vehicle 10.

The cooling control unit 53 causes the cooling device 40 to cool the battery 20 when the battery 20 is charged at a temperature exceeding the first upper limit temperature. Specifically, when the battery temperature acquired by the function of the acquisition unit 51 exceeds the first upper limit temperature, the cooling control unit 53 controls the cooling device 40 to cool the battery 20. For example, the cooling control unit 53 cools the battery 20 by the refrigerant (cooling water) cooled by the chiller 41a after the charging of the battery 20 and before traveling, and cools the battery 20 by the refrigerant (cooling water) cooled by the radiator 41b during traveling. In this case, since electric power is consumed due to cooling of the battery 20 by the cooling device 40, the cooling control unit 53 preferably controls the cooling device 40 such that an amount of electric power consumed by operating the cooling device 40 is equal to or less than a predetermined amount of electric power determined in advance with respect to a charging amount in the quick charging.

When the battery temperature is lower than the first upper limit temperature, the cooling control unit 53 may not operate the cooling device 40 because the battery 20 can be cooled to an outside air temperature by the outside air during traveling.

### Time Chart

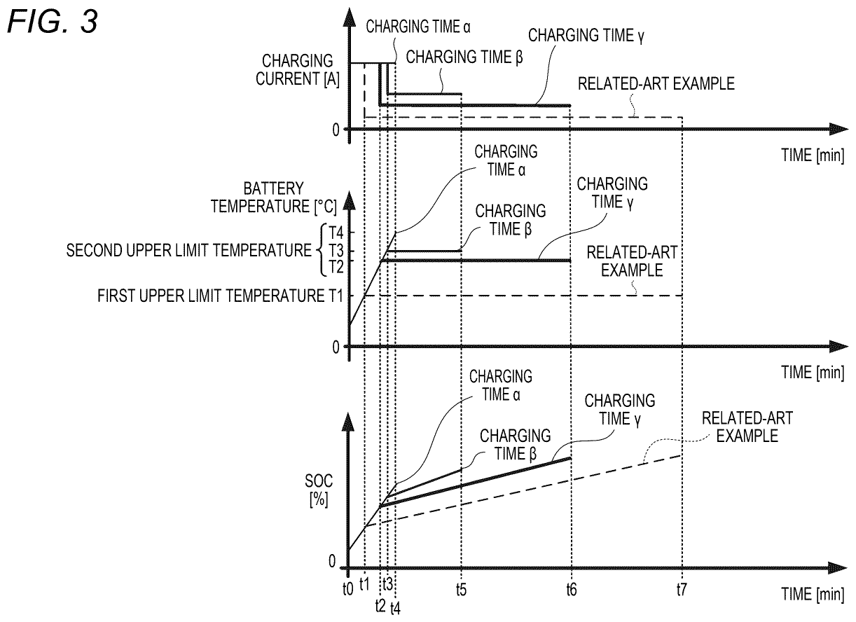

Next, changes in the charging current, the battery temperature, and an SOC when a process in a case where the charging time is designated is performed will be described with reference to a time chart. FIG. 3 is a diagram showing an example of the time chart, in which vertical axes represent the charging current, the battery temperature, and the SOC, and horizontal axes represent time. In the time chart shown in FIG. 3, as an example in which the designated charging time is within the predetermined time, changes in each of the parameters in cases of the charging time α, the charging time β, and the charging time γ are shown, and changes in each of the parameters in a case of a time longer than the predetermined time in a related-art example are shown. The related-art example is an example in which, when the battery temperature reaches the upper limit temperature T1, charging at a higher temperature is not allowed. In the example of FIG. 3, solid lines having different thicknesses indicate changes in the parameters in the present embodiment, and broken lines indicate changes in the parameters in the related-art example.

Specifically, first, when the charging of the battery 20 is started at a time to, the charging current is controlled to the maximum current in any of the present embodiment and the related-art example. Then, as the charging is started, the battery temperature increases, the SOC increases accordingly, and the parameters change at the same change rate in any of the examples.

Next, at a time t1, the battery temperature reaches the upper limit temperature T1. Here, in the related-art example, the battery temperature reaches the upper limit temperature. Therefore, the charging current is limited to a predetermined value. Accordingly, the increase rate of the SOC decreases, and the SOC continues to increase at the decreased increase rate. In the present embodiment, at the time t1, the parameters have the same change rate in any of the examples.

Then, at a time t2, the battery temperature reaches T2. Here, in an example of the charging time γ, the battery temperature reaches the second upper limit temperature. Therefore, the charging current is limited to a predetermined value (a value larger than that in the related-art example). Accordingly, the increase rate of the SOC decreases, and the SOC continues to increase at the decreased increase rate.

Then, at a time t3, the battery temperature reaches T3. Here, in an example of the charging time β, the battery temperature reaches the second upper limit temperature. Therefore, the charging current is limited to a predetermined value (a value larger than that in the example of the charging time γ). Accordingly, the increase rate of the SOC decreases, and the SOC continues to increase at the decreased increase rate.

Then, at a time t4, the battery temperature reaches T4. Here, in an example of the charging time α, the battery temperature reaches the second upper limit temperature, and the charging is completed when the charging time elapses.

Next, at a time t5, in the example of the charging time β, the charging is completed when the charging time elapses.

Next, at a time t6, in the example of the charging time γ, the charging is completed when the charging time elapses.

Then, at a time t7, in the related-art example, the charging is completed when the charging time elapses.

As can be grasped from the time chart of FIG. 3, when the same charging time on the horizontal axis is viewed, the charging amount can be increased as the designated charging time becomes shorter.

Each of the upper limit temperatures T1 to T4 described above is assumed to be, for example, the following temperature. For example, it is assumed that T1 indicating the first upper limit temperature is 120 [° C.], T2 indicating the second upper limit temperature is 130 [° C.], T3 is 140 [° C.], and T4 is 150 [° C.].

Each of the charging times t4 to t7 described above is assumed to be, for example, the following charging time. For example, it is assumed that the charging time t4 is 5 [min], the charging time t5 in the example of the charging time β is 10 [min], the charging time t6 in the example of the charging time γ is 20 [min], and the charging time t7 in the related-art example is 30 [min].

As described above, in the present embodiment, the battery 20 is implemented by the all-solid-state battery. When the charging time for charging the battery 20 is longer than the predetermined time, the control device 50 sets the upper limit temperature of the battery 20 to the first upper limit temperature that is a temperature considering the durability of the all-solid-state battery, and performs the charging control of the battery 20. On the other hand, when the charging time is equal to or shorter than the predetermined time, the upper limit temperature of the battery 20 is set to the second upper limit temperature higher than the first upper limit temperature to perform the charging control of the battery 20. That is, when the charging time is equal to or shorter than the predetermined time, the charging control of the battery 20 is performed with the battery temperature allowed to exceed the first upper limit temperature. In this way, by changing the upper limit temperature according to the charging time of the battery 20, the battery 20 can be efficiently charged in a limited charging time while preventing deterioration of the battery 20. That is, as described above with reference to the time chart of FIG. 3, in the present embodiment, when the charging time is within the predetermined time, the battery can be more charged in the same charging time as compared with the related-art example. Enabling the efficient charging can ultimately contribute to improving energy efficiency.

By enabling the efficient charging, for example, it is possible to increase a possibility that a charging amount desired by the user can be secured in a short rest time in a parking area of an expressway or the like.

Further, in the present embodiment, the first upper limit temperature described above indicates a temperature higher than the upper limit temperature that can be set in the liquid battery, and therefore, a possibility that the battery temperature restricts the charging is lower than in the liquid battery. That is, in the liquid battery, since the upper limit temperature of the battery temperature is lower than that of the all-solid-state battery, when the battery temperature reaches the upper limit temperature, it can be assumed to switch from the quick charging to the normal charging or to interrupt or stop the charging itself, but in the present embodiment, a possibility of such an event occurring is low. In this way, by using the battery 20 using the all-solid-state battery, the charging efficiency can be improved as compared with a case of using the liquid battery.

In the present embodiment, the second upper limit temperature is a temperature in a predetermined temperature range higher than the first upper limit temperature, and the control device 50 sets the second upper limit temperature to be relatively higher within the predetermined temperature range as the charging time becomes shorter. That is, the control device 50 increases the upper limit temperature in the predetermined temperature range as the designated charging time becomes shorter. Accordingly, for example, as shown in the time chart of FIG. 3, when the SOC at the same charging time is viewed, the charging amount can be increased as the charging time becomes shorter, in other words, the charging amount corresponding to the charging time can be optimized.

In the present embodiment, since the upper limit temperature is at least equal to or higher than a heat-resistant temperature of the liquid battery, the battery temperature may be equal to or higher than the heat-resistant temperature of the liquid battery, but the battery 20 is cooled by the outside air during traveling of the vehicle 10. Accordingly, the battery 20 can be effectively cooled when the vehicle 10 is traveling.

In the present embodiment, the control device 50 causes the cooling device 40 to cool the battery 20 when the battery 20 is charged at a temperature exceeding the first upper limit temperature. That is, as described above, the battery 20 is cooled by the chiller 41a after the battery 20 is charged and before traveling, and the battery 20 is cooled by the radiator 41b after traveling. Thus, the battery 20 can be effectively cooled.

### Another Embodiment

Next, another embodiment will be described. In the embodiment described above, the second upper limit temperature is set for each charging time within the predetermined time, and the charging current of the battery 20 is decreased to the predetermined charging current when the battery temperature reaches the second upper limit temperature. Meanwhile, in the configuration, the charging control means is not limited to the means described above as long as the charging efficiency can be improved while preventing the deterioration of the battery.

For example, in the embodiment described above, the second upper limit temperature is set to be higher in the predetermined temperature range as the charging time becomes shorter, but the second upper limit temperature may be set to the same temperature, and in this case, the control device 50 changes the timing of decreasing the charging current (in other words, limiting the charging current) based on the battery temperature for each charging time. Specifically, when the charging is performed at the second upper limit temperature, by using a function of the charging control unit 52, the control device 50 controls the charging current to gradually decrease from the maximum current based on the charging time and the temperature of the battery, and sets the temperature of the battery 20 at which the decrease from the maximum current is started to be lower as the charging time becomes longer. By gradually decreasing the charging current, the change rate of the increase in the battery temperature decreases, and the battery temperature reaches the second upper limit temperature at a time point when the charging time elapses.

In this way, the battery temperature at which the charging current is decreased is controlled according to the charging time, but in other words, a time taken to set the charging current of the battery 20 to the maximum current may be controlled according to the charging time. That is, as the charging time becomes longer, the time taken to set the charging current to the maximum current becomes shorter (in other words, as the charging time becomes shorter, the time taken to set the charging current to the maximum current becomes longer).

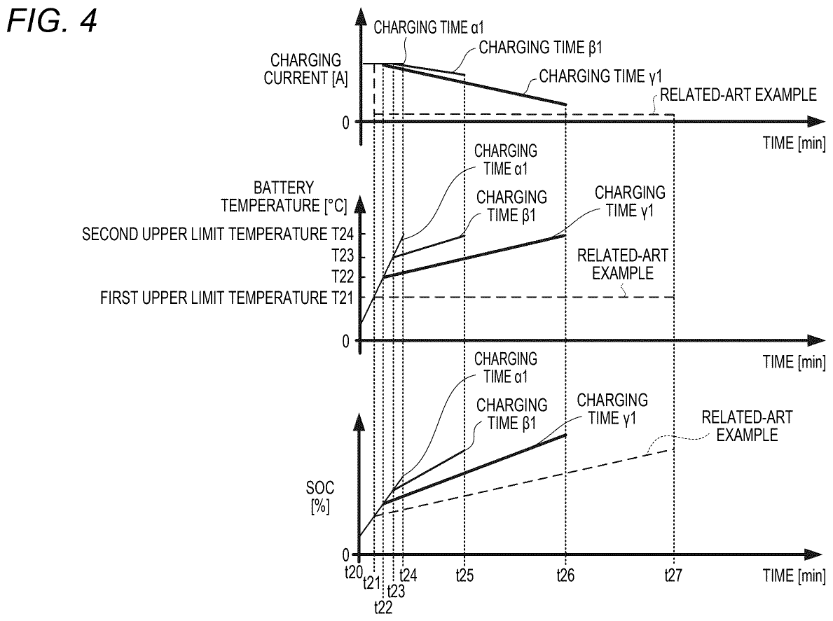

FIG. 4 is a time chart showing an example of the changes in the charging current, the battery temperature, and the SOC when charging control according to another embodiment is performed. Similarly to the example described in FIG. 3, vertical axes represent the charging current, the battery temperature, and the SOC, and horizontal axes represent time. In the time chart shown in FIG. 4, as an example in which the designated charging time is within the predetermined time, the changes in each of the parameters in cases of a charging time α1, a charging time β1, and a charging time γ1 are shown, and the changes in each of the parameters in a case of a time longer than the predetermined time in the related-art example are shown. In the example of FIG. 4, solid lines having different thicknesses indicate changes in the parameters in the other embodiment, and broken lines indicate changes in the parameters in the related-art example. In the example shown in FIG. 4, the first upper limit temperature is T21, and the second upper limit temperature is T24.

Specifically, first, when the charging of the battery 20 is started at a time t20, the charging current is controlled to the maximum current in any of the other embodiment and the related-art example. Then, as the charging is started, the battery temperature increases, the SOC increases accordingly, and the parameters change at the same change rate in any of the examples.

Then, at a time t21, the battery temperature reaches T21. Here, in the related-art example, the battery temperature reaches the upper limit temperature. Therefore, the charging current is limited to a predetermined value. Accordingly, the increase rate of the SOC decreases, and the SOC continues to increase at the decreased increase rate. In the other embodiments, at the time t21, the parameters have the same change rate in any of the examples.

Then, at a time t22, the battery temperature reaches T22. Here, in an example of the charging time γ1, when the charging current is kept at the maximum current until the charging time elapses, the battery temperature may reach the second upper limit temperature T24 before the charging is completed, and thus the charging current starts to decrease from the maximum current at this time. In the other embodiment, when the charging current is decreased, the charging current is not decreased to a predetermined charging current as in the related-art example, and the charging current is gradually decreased such that the charging current becomes a predetermined charging current before the charging is completed as the charging time elapses. By controlling the charging current in this way, the change rate in the increase in the battery temperature in the example of the charging time γ1 is reduced. Accordingly, the increase rate of the SOC decreases, and the SOC continues to increase at the decreased increase rate.

Then, at a time t23, the battery temperature reaches T23. Here, in an example of the charging time β1, when the charging current is kept at the maximum current until the charging time elapses, the battery temperature may reach the second upper limit temperature T24 before the charging is completed, and thus the charging current starts to decrease from the maximum current at this time and gradually decreases to a predetermined charging current. By controlling the charging current in this way, the change rate in the increase in the battery temperature in the example of the charging time 1 is reduced. Accordingly, the increase rate of the SOC decreases, and the SOC continues to increase at the decreased increase rate.

Then, at a time t24, the battery temperature reaches T24. Here, in an example of the charging time α1, the battery temperature reaches the second upper limit temperature T24, and the charging is completed when the charging time elapses.

Next, at a time t25, in the example of the charging time β1, the battery temperature reaches the second upper limit temperature T24, and the charging is completed when the charging time elapses.

Next, at a time t26, in the example of the charging time γ1, the battery temperature reaches the second upper limit temperature T24, and the charging is completed when the charging time elapses.

Then, at a time t27, in the related-art example, the charging is completed when the charging time elapses.

Each of the upper limit temperatures T21 to T24 described above is assumed to be, for example, the following temperature. For example, it is assumed that T21 indicating the first upper limit temperature is 120 [° C.], T24 indicating the second upper limit temperature is 150 [° C.], T22 between the first upper limit temperature and the second upper limit temperature is 130 [° C.], and T23 between the first upper limit temperature and the second upper limit temperature is 140 [° C.].

Similarly, each of the charging times t24 to t27 described above is assumed to be, for example, the following charging time. For example, it is assumed that the charging time t24 is 5 [min], the charging time t25 is 10 [min], the charging time t26 is 20 [min], and the charging time t27 in the related-art example is 30 [min].

As described above, in the other embodiment, more charging can also be performed in the same charging time as compared with the related-art example. That is, the charging efficiency of the battery 20 can be improved. Further, as can be grasped from FIG. 4, when the SOC at the same charging time is viewed, the charging amount can be increased as the charging time becomes shorter, in other words, the charging amount corresponding to the charging time can be optimized.

### Others

Although an embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure.

For example, in the embodiment described above, when the battery 20 is charged at a temperature exceeding the first upper limit temperature, the cooling control unit 53 operates the cooling device 40 to cool the battery 20, but the cooling may be performed in a state where the temperature does not exceed the first upper limit temperature. In this case, it is preferable to perform the cooling with a power consumption amount for operating the cooling device 40 at least being smaller than the charging amount.

In the embodiment described above, the charging current is controlled when the charging power is reduced, but the charging power may be reduced by controlling a charging voltage.

The control method described in the above embodiment may be implemented by executing a control program prepared in advance on a computer. The control program is stored in a computer-readable storage medium and executed by being read from the storage medium. The control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present specification, at least the following matters are described. Although corresponding constituent elements in the embodiment described above are shown in parentheses, the present disclosure is not limited thereto.

(1) A control device (control device 50) which controls a vehicle (vehicle 10) including a battery (battery 20) implemented by an all-solid-state battery, the control device including:
an acquisition circuit (acquisition unit 51) configured to acquire a battery temperature that is a temperature of the battery; and
a charging control circuit (charging control unit 52) configured to, when the battery temperature acquired by the acquisition circuit reaches a predetermined upper limit temperature during charging of the battery, stop the charging of the battery or decrease a charging current as compared with before the battery temperature reaches the upper limit temperature, in which
the charging control circuit
   sets the upper limit temperature to a first upper limit temperature when a charging time for charging the battery is longer than a predetermined time, and
   sets the upper limit temperature to a second upper limit temperature higher than the first upper limit temperature when the charging time is equal to or shorter than the predetermined time.

According to (1), it is possible to efficiently charge (quickly charge) the battery in a limited charging time while preventing deterioration of the battery. Enabling the efficient charging in this way can ultimately contribute to improving energy efficiency.

(2) The control device according to (1), in which
the first upper limit temperature is a temperature higher than an upper limit temperature that is able to be set in a liquid battery.

According to (2), the battery temperature is less likely to restrict the charging as compared with the liquid battery, and as a result, the charging efficiency can be improved as compared with a case where a liquid battery is used as the battery.

(3) The control device according to (1), in which
the second upper limit temperature is a temperature in a predetermined temperature range higher than the first upper limit temperature, and
the charging control circuit sets the second upper limit temperature that is relatively higher within the predetermined temperature range as the charging time becomes shorter.

According to (3), when an SOC at the same charging time is viewed, a charging amount can be increased as the charging time becomes shorter, in other words, the charging amount corresponding to the charging time can be optimized.

(4) The control device according to (1), in which
when the charging is performed at the second upper limit temperature, the charging control circuit controls the charging current to gradually decrease from a maximum current allowed in the battery based on the charging time and the temperature of the battery, and sets the temperature of the battery at which the decrease from the maximum current is started to be lower as the charging time becomes longer.

According to (4), when the SOC at the same charging time is viewed, the charging amount can be increased as the charging time becomes shorter, in other words, the charging amount corresponding to the charging time can be optimized.

(5) The control device according to (1), in which
the battery is mounted on the vehicle in a state where the battery is able to be cooled by outside air.

According to (5), the battery can be cooled during traveling of the vehicle.

(6) The control device according to (1), in which
the battery is mounted on the vehicle in a state where the battery having a temperature three times or higher than an outside air temperature is able to be cooled.

According to (6), for example, even if the battery temperature is a high temperature such as 90 [° C.] or higher in midsummer such as an outside air temperature of 30 [° C.] or higher and once exceeds the upper limit temperature, since a temperature difference between the battery temperature and the outside air temperature is 60 [° C.] or higher, the battery can be rapidly cooled by traveling wind when the vehicle equipped with the battery travels. Therefore, an influence of the deterioration of the vehicle or the battery can be extremely reduced.

(7) The control device according to any one of (1) to (6), in which
the vehicle further includes a cooling device (cooling device 40) configured to cool the battery,
the control device further comprises a cooling control circuit (cooling control unit 53) configured to control the cooling device, and
the cooling control circuit causes the cooling device to cool the battery when the battery is charged at a temperature exceeding the first upper limit temperature.

According to (7), the battery can be cooled by the cooling device.

(8) A control method performed by a computer which controls a vehicle (vehicle 10) including a battery (battery 20) implemented by an all-solid-state battery, the control method including:
acquiring a battery temperature that is a temperature of the battery;
when the acquired battery temperature reaches a predetermined upper limit temperature during charging of the battery, stopping the charging of the battery or decreasing a charging current as compared with before the battery temperature reaches the upper limit temperature;
setting the upper limit temperature to a first upper limit temperature when a charging time for charging the battery is longer than a predetermined time; and
setting the upper limit temperature to a second upper limit temperature higher than the first upper limit temperature when the charging time is equal to or shorter than the predetermined time.

According to (8), it is possible to efficiently charge (quickly charge) the battery in a limited charging time while preventing the deterioration of the battery.

1. A control device which controls a vehicle including a battery implemented by an all-solid-state battery, the control device comprising:
an acquisition circuit configured to acquire a battery temperature that is a temperature of the battery; and
a charging control circuit configured to, when the battery temperature acquired by the acquisition circuit reaches a predetermined upper limit temperature during charging of the battery, stop the charging of the battery or decrease a charging current as compared with before the battery temperature reaches the predetermined upper limit temperature, wherein
the charging control circuit
sets the upper limit temperature to a first upper limit temperature when a charging time for charging the battery is longer than a predetermined time, and
sets the upper limit temperature to a second upper limit temperature higher than the first upper limit temperature when the charging time is equal to or shorter than the predetermined time.

2. The control device according to claim 1, wherein
the first upper limit temperature is a temperature higher than an upper limit temperature that is able to be set in a liquid battery.

3. The control device according to claim 1, wherein
the second upper limit temperature is a temperature in a predetermined temperature range higher than the first upper limit temperature, and
the charging control circuit sets the second upper limit temperature that is relatively higher within the predetermined temperature range as the charging time becomes shorter.

4. The control device according to claim 1, wherein
when the charging is performed at the second upper limit temperature, the charging control circuit controls the charging current to gradually decrease from a maximum current allowed in the battery based on the charging time and the temperature of the battery, and sets the temperature of the battery at which the decrease from the maximum current is started to be lower as the charging time becomes longer.

5. The control device according to claim 1, wherein
the battery is mounted on the vehicle in a state where the battery is coolable by outside air.

6. The control device according to claim 1, wherein
the battery is mounted on the vehicle in a state where the battery having a temperature three times or higher than an outside air temperature is coolable.

7. The control device according to claim 1, wherein
the vehicle further includes a cooling device configured to cool the battery,
the control device further comprises a cooling control circuit configured to control the cooling device, and
the cooling control circuit causes the cooling device to cool the battery when the battery is charged at a temperature exceeding the first upper limit temperature.

8. A control method performed by a computer which controls a vehicle including a battery implemented by an all-solid-state battery, the control method comprising:
acquiring a battery temperature that is a temperature of the battery;
when the acquired battery temperature reaches a predetermined upper limit temperature during charging of the battery, stopping the charging of the battery or decreasing a charging current as compared with before the battery temperature reaches the upper limit temperature;
setting the upper limit temperature to a first upper limit temperature when a charging time for charging the battery is longer than a predetermined time; and
setting the upper limit temperature to a second upper limit temperature higher than the first upper limit temperature when the charging time is equal to or shorter than the predetermined time.
